(19) United States
(12) Patent Application Publication
(10) Pub. No.: US 2025/0052370 A1
(43) Pub. Date: Feb. 13, 2025

(54) INSULATING DEVICE AND METHOD FOR MANUFACTURING AN INSULATING DEVICE

(71) Applicant: FESTO SE & CO. KG, Esslingen (DE)

(72) Inventors: Stephan SCHAUZ, Geislingen an der Steige (DE); Frank HAUBER, Wernau (DE)

(21) Appl. No.: 18/718,689

(22) PCT Filed: Nov. 24, 2022
(86) PCT No.: PCT/EP2022/083110

§ 371 Date: Jun. 11, 2024

(30) Foreign Application Priority Data
Dec. 14, 2021 (DE) 10 2021 214 273.7

(51) Int. Cl. F17C 1/12

(52) U.S. Cl. CPC F17C 1/12; F17C 2201/0119; F17C 2203/017; F17C 2203/0391; F17C 2203/0629

(57) ABSTRACT

An insulating device for insulating a useable space from an external environment, with an inner shell which borders a useable space and which is surrounded by an outer shell, the inner shell being movably accommodated in the outer shell and delimiting an insulating space with the outer shell, and the inner shell being assigned a superconductor is assigned to the inner shell, and with a magnet assigned to the outer shell, which magnet enables a force-transmitting interaction with the superconductor for the contactless provision of supporting forces for the inner shell.

The invention relates to an insulating device for insulating a useable space from an external environment, and to a method for manufacturing an insulating device.

The state of the art includes, for example, a container for storing liquefied gas, also known as a Dewar vessel, which can be used for storing and transporting liquefied gas or another, preferably flowable substance at a temperature significantly lower than the typical room temperature of 20 degrees Celsius, in particular in the range from minus 150 degrees Celsius to minus 200 degrees Celsius.

The object of the invention is to provide an insulating device with improved insulating properties and a method for producing an inner shell for such an insulating device.

This task is solved by the invention in that the insulating device has an inner shell which borders a useable space and which is surrounded by an outer shell, the inner shell being movably received in the outer shell and delimiting an insulating space with the outer shell and wherein the inner shell is assigned a superconductor, as well as a magnet assigned to the outer shell, which is designed for a force-transmitting interaction with the superconductor for the contactless provision of supporting forces for the inner shell.

The usable space bounded by the inner shell has at least one opening, so that the usable space can be used, for example, to store a liquefied gas, which can be filled into the usable space through this opening or removed from the usable space through this opening. Alternatively, it is envisaged that the usable space has several openings, in particular at the opposite ends of the usable space, and can thus be used, for example, in the manner of a pipeline for the transportation of a liquefied gas. The inner shell is made of a material that is designed to store and transport substances at a temperature of 100 Kelvin or less without the material of the inner shell becoming brittle in a way that would jeopardize the function of the inner shell. It is preferably envisaged that the inner shell will only undergo elastic deformation and will not be plastically deformed or cracked, at least within the scope of the intended use and taking into account any excess pressure in the usable space and/or taking into account the mass of the fluid to be accommodated in the usable space. The inner shell is preferably designed in such a way that it is considered to be dimensionally stable or form-retaining when the Insulating device is used as intended. The outer shell has similar properties to the inner shell, and it is preferably intended that the outer shell also undergoes only elastic deformation when the Insulating device is used as intended and is considered to be dimensionally stable or form-retaining. The outer shell is designed to provide mechanical protection for the inner shell and for the insulation space formed between the inner shell and the outer shell. On the other hand, the outer shell has the task of supporting one or more magnets, preferably a permanent magnet device, which magnets are designed for the force-transmitting interaction with a magnet assigned to the inner shell, in particular a permanent magnet and/or a superconductor.

The magnet associated with the inner shell can be fixed optionally, in particular partially, in the useable space and thus on an inner surface of the inner shell and/or outside the useable space and thus on an outer surface of the inner shell. In addition, or alternatively, it can be provided that the superconductor is at least partially integrated into the material of the inner shell.

The magnet assigned to the inner shell has the task of providing a force-transmitting interaction with the magnet of the outer shell in order to enable the contactless provision of supporting forces for the inner shell. This force-transmitting interaction between the magnets can reduce mechanical contact between the inner shell and the outer shell to a minimum, in particular to zero. This minimizes convective heat transfer from the outer shell to the inner shell, which means that the insulating device can achieve a long-lasting insulating effect. The superconductor, which is assigned to the inner shell, and which may be designed as a component of the inner shell, preferably comprises at least one so-called high-temperature superconductor or type-II superconductor, i.e. it is made of a material that exhibits superconducting properties far from the absolute zero of 0 Kelvin. YBCO (yttrium barium copper oxide) is an example of a superconductor material, whose transition temperature is minus 181 degrees Celsius and which, for example, when cooled by liquefied nitrogen, which has a temperature of less than minus 192 degrees Celsius, exhibits superconducting properties.

To ensure that the insulating device functions properly, it is intended that the inner shell be brought into a functional position using suitable means, in particular by applying external forces, before the insulating device is put into operation, in particular before a liquefied gas is supplied that has a temperature below the transition temperature of the superconducting device. This functional position should be maintained by the inner shell with respect to the outer shell during the subsequent intended use, or it is intended that this functional position should at least be in close spatial proximity to a desired functional position for the inner shell with respect to the outer shell.

The substance or fluid, which has a temperature below the transition temperature of the superconductor, is then fed into the useable space. This effectively programs the superconductor to the magnetic flux provided by the magnet. If the temperature of the superconductor subsequently remains below the material-specific transition temperature, the superconductor, in interaction with the magnet, provides reaction forces when the inner shell is deflected from the “programmed” functional position, which ensure that the inner shell remains at least essentially in the desired functional position.

The aforementioned effect of “programming” the superconducting device is also referred to as pinning, whereby eddy current flux tubes are created in the superconducting device, which can be maintained without loss due to the superconducting properties of the material of the superconducting device until the superconducting device is heated above its material-specific transition temperature again. The advantage of using superconducting material is that, in interaction with the magnet of the outer shell, a stable positioning of the inner shell relative to the outer shell can be achieved without the need for control or regulation or an energy supply.

Advantageous further developments of the invention are the subject of the subclaims.

It is advantageous if the insulating space between the inner shell and the outer shell is gas-tight, in particular evacuated. In order to ensure an advantageous insulating effect for the insulating device, it is advantageous if only a small number of molecules are present in this insulating space that could cause heat to be transported from the outer shell to the inner shell. Accordingly, it is preferably provided that the gas-tight insulating space is at least largely evacuated, so that the number of molecules in the insulating space is minimal compared to an ambient situation for the insulating device in which atmospheric conditions prevail.

It is advantageous if a supporting element is arranged in the insulating space between the inner shell and the outer shell, which supporting element is designed to be elastically deformable or deformable in a shape-changing manner when the temperature drops below the material-specific transition temperature of the superconducting device, and which is designed to support the weight of the inner shell. The purpose of the supporting element is to bring the inner shell into a position relative to the outer shell that at least substantially corresponds to the functional position for the inner shell relative to the outer shell after a supply of a material or fluid whose temperature is below the transition temperature for the superconductor. The supporting element is preferably made of a material that has a high thermal resistance and thus a low thermal conductivity coefficient. Preferably, the supporting element is dimensioned in such a way that it can hold the inner shell in a position that at least essentially corresponds to a later position of the inner shell relative to the outer shell after the insulating device has been put into operation. Furthermore, it is envisaged that the supporting element is designed to be elastically deformable in such a way that a relative movement between the inner and outer shells is hindered as little as possible during the intended use of the Insulating device. Alternatively, it may be provided that the supporting element is designed in such a way, by means of a suitable choice of material and/or a suitable geometric design, that it ensures support of the weight force between the inner and outer shells at temperatures above the material-specific transition temperature of the superconducting device and, when the temperature falls the material-specific transition temperature of the superconducting device, it undergoes a significant, in particular abrupt, change in shape, which ensures that a conductive coupling between the inner and outer shells that existed before the transition temperature is reached is eliminated once the transition temperature is undershot. For example, the supporting element can be made of two materials with different temperature-dependent coefficients of expansion, so that when the transition temperature is undershot, an internal stress in the supporting element brings about the desired change in shape. It is assumed that this change in shape is reversible, and that the supporting element automatically returns to its original shape when the temperature in the insulating container rises, so that the desired support effect between the inner and outer shells is ensured at temperatures above the material-specific transition temperature of the superconductor.

It is preferred that the magnet is arranged in a movable manner on the outer shell. This allows a magnetic interaction between the magnet and the superconductor to be adapted to the mass of the inner shell to be supported, depending on the use of the usable space, for example by filling the usable space with a fluid or by removing fluid from the usable space. For example, it is envisaged that the magnet is attached to the outer shell in a linearly movable manner and that a manual adjustment for positioning the magnet by a user or an automated position change for the magnet is envisaged.

In a further development of the invention, it is envisaged that the inner shell is formed with a constant profile along a, in particular, straight profile section and that a plurality of permanent magnets and/or superconductors are arranged along the profile section, in particular at equal intervals. For example, it is envisaged that the inner shell is tubular along the profile section, in particular with a circular profile, and that a plurality of permanent magnets and/or superconductors are arranged along this straight profile section in order to be able to exert as uniform a supporting effect as possible on the inner shell. Such an arrangement of a plurality of permanent magnets and/or superconductors on the inner shell is of particular interest if a length of the profile section of the inner shell is considerably greater than a maximum inner diameter of the inner shell.

In a further development of the invention, it is envisaged that the inner shell is designed as an inner tube and that the outer shell is designed as an outer tube and that the inner tube is connected to the outer tube at each end in a sealed manner. In this embodiment, the insulating device forms a tube section through which, for example, a liquefied gas, in particular liquefied nitrogen, can be transported with as little heating as possible. For example, an insulating device of this type can be used to create a fluidic connection between a fluid reservoir and a fluid consumer. In order to ensure the desired gas-tight design of the insulating space, the end regions of the inner tube that face away from each other are connected to the end regions of the outer tube that face away from each other in a sealed manner, whereby an annular connecting zone is to be provided for this purpose, which coaxially surrounds an opening for the useable space, which opening is arranged at the end of the insulating device.

In an alternative further development of the invention, it is envisaged that the inner shell is bottle-shaped and has an opening for the useable space, the bottle-shaped outer shell being connected to the inner shell in a sealed manner in the area of the opening. In this case, the insulating device serves as a container for holding a fluid or other flowable substance that has a temperature below the transition temperature of the superconducting device and is to remain at this temperature for a longer period of time. For this purpose, the substance or fluid can be filled into the bottle-shaped inner shell through the mouth opening, whereby a cross-section of the mouth opening is designed to be considerably smaller than a cross-section of the adjoining container section of the inner shell.

It is preferably provided that a first superconductor is arranged adjacent to a bottom region of the bottle-shaped inner shell and that a permanent magnet and/or a second superconductor is arranged on a side wall, preferably with a constant profile, in particular a circular cylindrical profile, which is formed between the bottom region and a neck region of the inner shell. The first superconductor of the inner shell and a corresponding magnet, in particular a permanent magnet on the outer shell, are designed to support the weight of the inner shell. The permanent magnets or superconductors attached to the side wall are designed to support the weight of the fluid to be stored.

In a further embodiment of the invention, it is envisaged that the inner shell is made, at least in part, of a composite material that includes a proportion of superconductor material. For example, it may be envisaged that the inner shell is made as a winding form, for example by winding one or more tape materials around a winding form, which are made, at least in part, of superconductor material or include superconductor material. Alternatively, it may be provided that the inner shell is manufactured from a thermoplastic material with a proportion of superconducting particles in a plastic injection molding process or from a thermosetting material with a proportion of superconducting particles in a casting process. In a further variant, it may be provided that an inner surface and/or an outer surface of the inner shell is provided with a coating that contains a superconducting material. For example, a lacquering or a flame spraying or a vaporization of the inner shell with superconducting material may be provided for this purpose.

The task of the invention is solved according to a second aspect by a method for producing an insulating device according to the invention. In this case, it is envisaged that the inner shell is produced by a method from the group: production of the inner shell by wrapping a winding form with one or more tape materials that are at least partially made of superconductor material or comprise superconductor material, production of the inner shell by plastic injection molding using a thermoplastic material that contains a proportion of superconducting particles, manufacturing the inner shell by coating an inner surface and/or an outer surface of a container blank with a superconducting material, and in a subsequent step, inserting it into the outer shell.

It may also be provided that a bottle-shaped or tubular casing is produced by wrapping a winding form with one or more tape materials that are at least partially made of superconductor material or comprise superconductor material, producing the inner shell by plastic injection molding using a thermoplastic material that contains a proportion of superconducting particles, producing the inner shell by a casting process using a thermosetting material containing a proportion of superconducting particles, producing the inner shell by coating an inner surface and/or an outer surface of a container blank with a superconducting material, and using this sheath for purposes other than installation in an insulating device.

When carrying out a winding process, it may be provided that the winding form is wound with different tape-like and/or thread-like materials, at least one of these materials being made of a superconducting material or containing a proportion of a superconducting material. In order to achieve a firm bond between the tape-like and/or thread-like materials and, finally, a sealingly formed sheath, in particular an inner shell, it may be provided that one or more of the tape-like and/or thread-like materials is coated with an adhesive which can be activated, for example, by external energy input such as ultraviolet light or thermal radiation. Alternatively, it may be provided that an adhesive is applied as an additional material to the winding mold with the tape-shaped and/or thread-shaped materials during or after the winding process.

Alternatively, it may be provided that the sheath, in particular the inner shell, is joined in a suitable form by introducing several layers of a flexible, in particular limp, fabric into the form and joining the fabric layers together with a suitable binder such as an adhesive, which is also referred to as a laminating process.

In a further alternative for the production of a casing, in particular an inner shell, it is possible to provide a container blank with a coating in the course of a coating process, which coating consists at least partially of a superconducting material. Coating processes such as painting, flame spraying or vapor deposition can be used here.

In a further advantageous development of the invention, an insulating layer, in particular a multilayer insulating film arrangement, is provided in the insulating space.

Advantageous embodiments of the invention are shown in the drawing. Here shows:

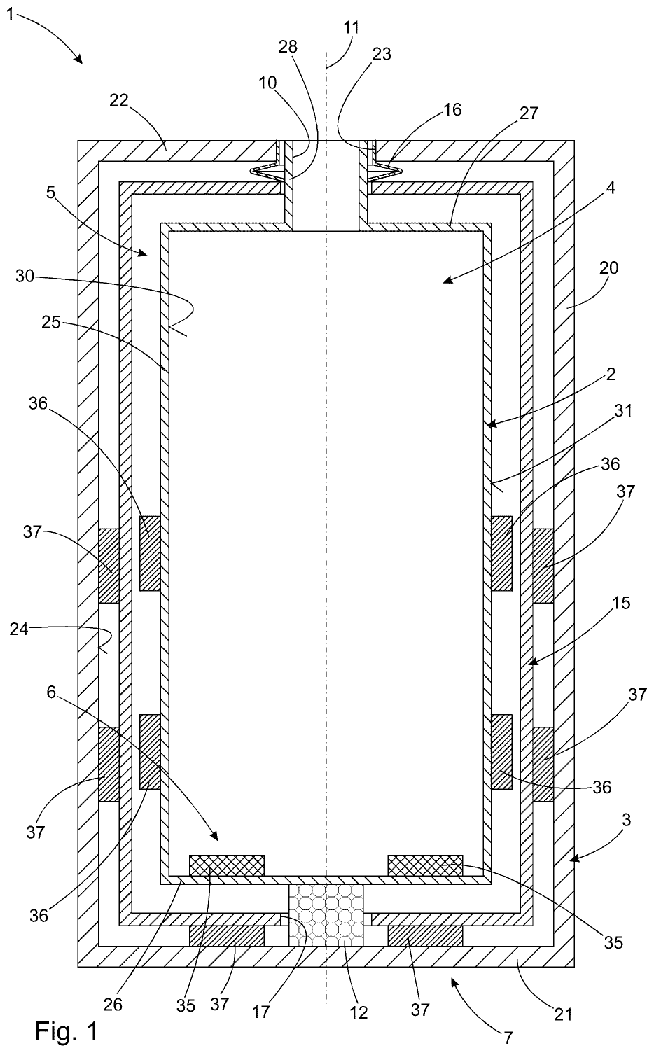

FIG. 1 a first embodiment of an insulating device with an outer shell, an insulating layer, an inner shell, a superconductor and a permanent magnet,

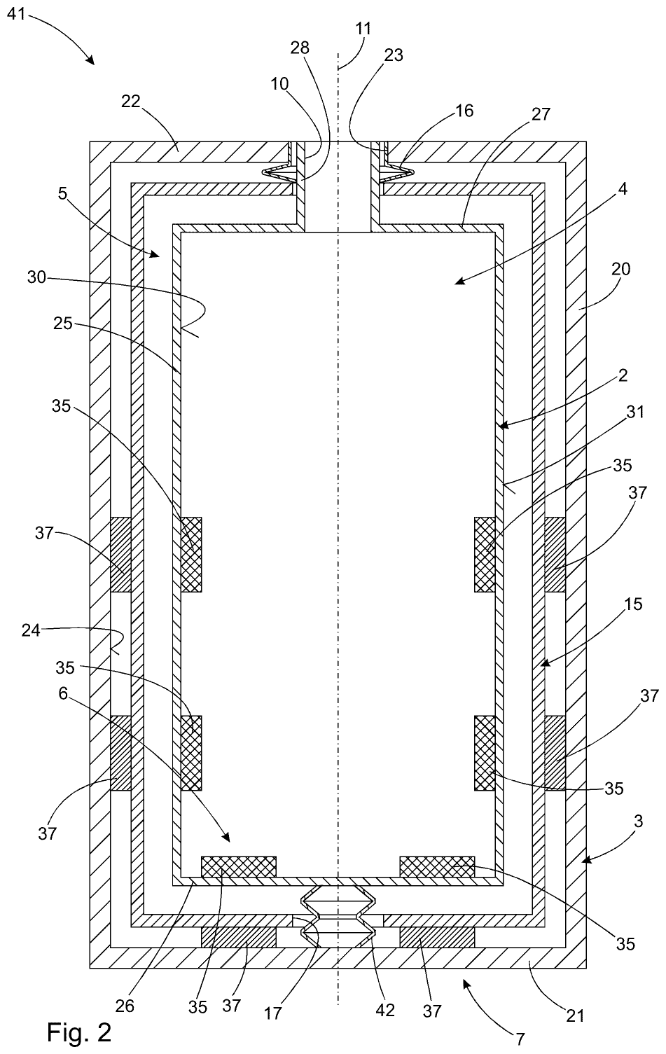

FIG. 2 a second embodiment of an insulating device, which is designed as a variant of the insulating device according to FIG. 1 and has a modified configuration with regard to the superconductor and the permanent magnet,

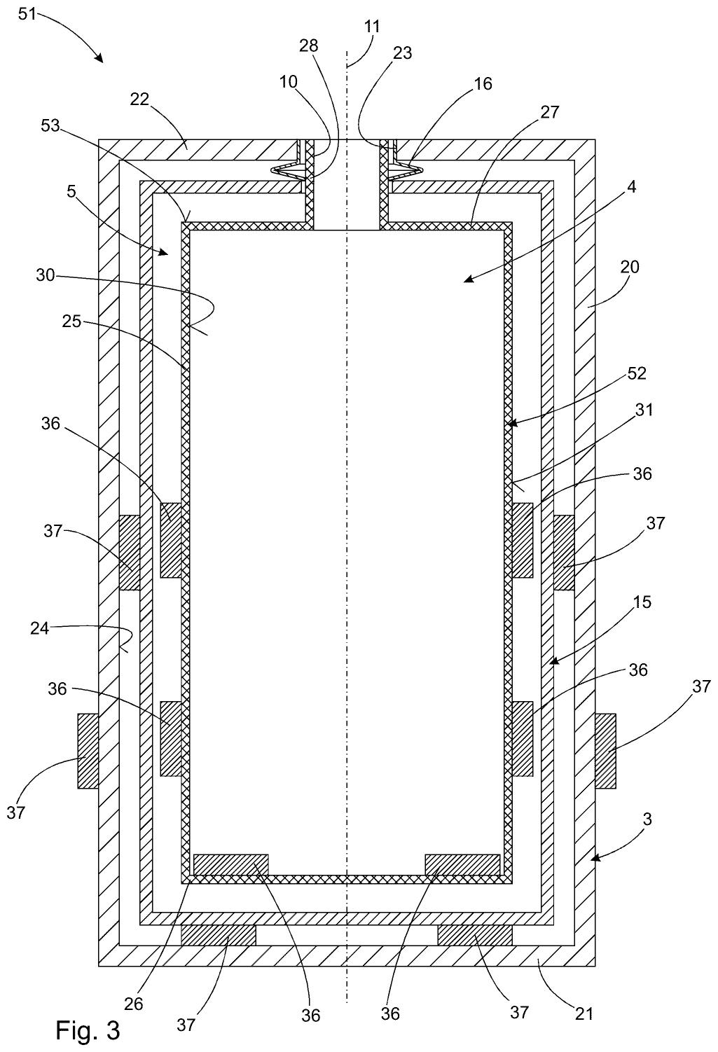

FIG. 3: a third embodiment of an insulating device in which the inner shell is made of a composite material, and

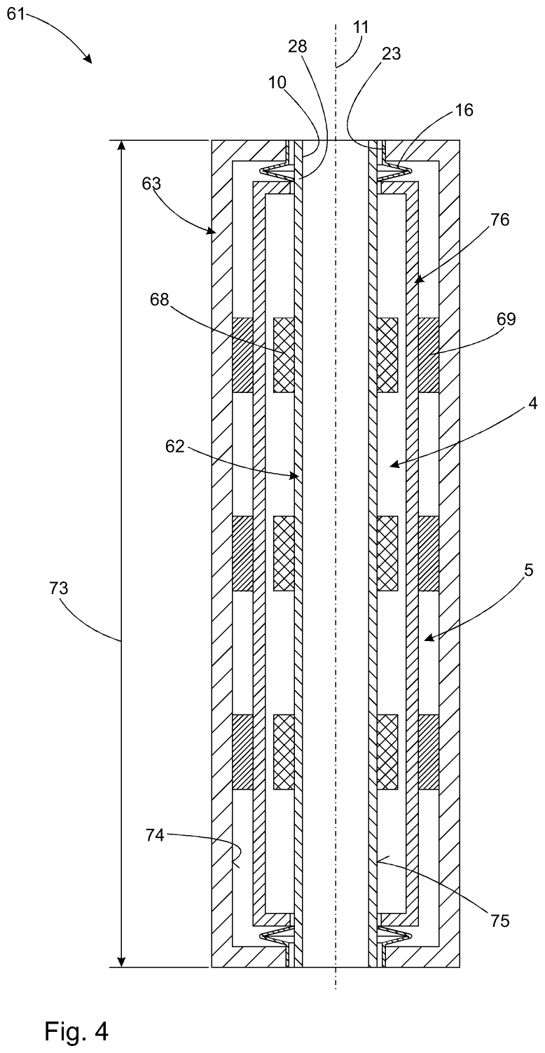

FIG. 4: a fourth embodiment of an insulating device, in which the outer and inner shells are tubular.

A first embodiment of an insulating device 1, shown in FIG. 1, is used to store a liquid, for example a liquefied gas such as nitrogen, the insulating device 1 being designed in such a way that the lowest possible heat transfer from an environment of the insulating device 1 into the liquid to be stored is ensured.

The insulating device 1 comprises, purely by way of example, an inner sleeve 2 in the form of a bottle, which is, for example, rotationally symmetrical with respect to an axis of symmetry 11. The inner sleeve 2 is accommodated in an outer sleeve 3, which is also, purely by way of example, rotationally symmetrical with respect to the axis of symmetry 11 and is at least almost completely enclosed by the outer sleeve 3. By way of example, it is envisaged that the outer shell 3 has a side wall 20 in the form of a circular cylindrical sleeve, a base area 21 in the form of a circular disk and a cover area 22 in the form of a circular ring. It is envisaged that the side wall 20 is preferably formed in one piece with the base area 21 and the cover area 22.

Furthermore, it is envisaged, by way of example, that the inner shell 2 has a side wall 25 in the form of a circular cylindrical sleeve, a base area 26 in the form of a circular disk and a lid area 27 in the form of a circular ring area 27, wherein a bottle neck 28, which is purely exemplary in the form of a circular cylindrical sleeve, adjoins the cover area 27 and borders a mouth opening 10. It is provided that the bottle neck 28 passes through a recess 23 in the lid area 22 of the outer shell 3.

An outer diameter of the side wall 25 of the inner shell 2 is chosen to be smaller than an inner diameter of the side wall 20 of the outer shell 3. Furthermore, a distance between the bottom area 26 and the lid area 27 of the inner shell 2 is chosen to be smaller than a distance between the bottom area 21 and the lid area 92 of the outer shell 3. The space between the inner shell 2 and the outer shell 3 is referred to as the insulating space 5. In the insulating space 5, which is preferably evacuated, an insulating film arrangement 15 is provided, which is constructed, for example, from a plurality of insulating film layers (not shown in more detail) and ensures thermal insulation between the outer shell 3 and the inner shell 2.

In order to ensure that the insulating space 5 is gas-tight, a rotationally symmetrical sealing element 16 is provided, which is fixed both in the recess 23 and on the bottle neck 28. The sealing element 16 is partially designed in the manner of a bellows, thereby enabling a linear relative movement along the axis of symmetry 11 between the inner shell 2 and the outer shell 3.

By way of example, the outer shell 3 and the sealing element 16 are made of a metallic material. The inner shell 2 can optionally be made of a metallic or ceramic or glass-like material or a plastic.

As can also be seen from FIG. 1, a supporting element 12 is arranged between the bottom area 26 of the inner shell 2 and the bottom area 21 of the outer shell 3, which is intended to support the weight of the inner shell 2. As an example, the supporting element 12 is made of a foam material, in particular an elastically deformable foam material, with low thermal conductivity. In order to ensure a force-transmitting connection between the inner shell 2 and the outer shell 3, the supporting element 12 is intended to pass through the insulating film arrangement 15, which is provided with a recess 17 for this purpose.

A superconductor arrangement 6 is arranged on an inner surface 30 of the inner shell 2, while a permanent magnet 7 is arranged on an outer surface 31 of the inner shell 2. In this case, the superconductor arrangement 6 comprises, purely by way of example, two cuboid superconductors 35, which are arranged in the base region 26. The permanent magnet 7 comprises, purely by way of example, four permanent magnets 36 which are arranged on the side wall 25 so as to project radially outwards.

On an inner surface 24 of the outer shell 3, cuboid permanent magnets 37 are arranged on both the side wall 20 and the base area 21, as an example. A total of six permanent magnets 37 are arranged on the outer shell, with the permanent magnets 37 arranged on the base area 21 being arranged vertically below the superconductors 35, as shown in FIG. 1. The permanent magnets 37 attached to the side wall 20 are arranged radially outwards adjacent to the permanent magnets 36 of the inner shell 2 but are located closer to the bottom area 21 than the permanent magnets 36.

When the inner shell, which is in the form of a bottle, is filled with a substance that has a temperature below the transition temperature of the superconductors 35, the superconductors 35 at the bottom area 26 of the inner shell 2 are brought into a superconducting state by contact with the substance, whereby the magnetic fields of the permanent magnets 37 arranged opposite on the bottom area 21 of the outer shell 3 are stored in the superconducting elements 35 by pinning. When the inner shell 2 is filled further, the increasing weight causes an elastic deformation of the supporting element 12 and thus a change in the distance between the superconductors 35 and the opposing permanent magnets 37, which causes reaction forces between the superconductors 35 and the permanent magnets 37 that counteract this linear displacement of the inner shell.

Furthermore, the permanent magnets 36, which are slightly spaced apart in the vertical direction, and the permanent magnets 37, which are attached to the side wall of the outer shell 3, interact magnetically and thus form a magnetically pre-stressed system. If the weight of the inner shell 2 increases further due to further filling with the cold substance, a possible linear displacement of the inner shell 2 with respect to the outer shell 3 will result in an increase in the magnetic interaction between the permanent magnets 36 and 37, so that an additional supporting effect in the vertical direction is produced for the inner shell 2.

The superconductors 35, the permanent magnets 36 and 37, the supporting element 12 and the sealing element 16 are preferably coordinated with one another in such a way that the majority of the supporting forces for the inner shell are produced by contactless magnetic interaction between the superconductor 6 and the permanent magnet 7. This means that the supporting element 12 and the sealing element 16 can be designed to be as filigree or thin walled as possible, thus allowing only a small amount of heat to enter the insulating space 5.

In the second embodiment according to FIG. 2, the same reference signs are used for functionally identical components as in the first embodiment according to FIG. 1. In contrast to the Insulating device 1 according to FIG. 1, the inner shell 2 of the Insulating device 41 is equipped exclusively with superconductors 35. Furthermore, a supporting element 42 is provided, which is shaped in the manner of a rotationally symmetrical bellows. The supporting element 42 is preferably made of a material or a combination of materials that causes the supporting element 42 to shorten when the temperature falls below a predeterminable temperature, in particular when the transition temperature of the superconductors 35 is undershot. If it is also provided that the supporting element 42 is attached to the underside of the inner shell 2, a supporting effect by the supporting element 42 and thus a thermally conductive coupling between the inner shell 2 and the outer shell 3 can be eliminated as soon as the critical temperature of the superconductors 35 is undershot by filling a cold substance into the working space 4 of the inner shell 2 and the superconductors 35 are in magnetic interaction with the permanent magnets 37, so that no support of the inner shell 2 by the supporting element 42 is required anymore. If the inner shell 2 is heated again above the transition temperature of the superconductors 35 at a later point in time, the length of the supporting element 42 also changes again to the length expansion as shown in FIG. 2. This ensures that the inner shell 2 is supported again by the supporting element 42 at this point in time.

In the third embodiment according to FIG. 3, the same reference signs are used for functionally identical components as in the first embodiment according to FIG. 1. The insulating device 51 differs from the insulating device 1 in that the inner shell 52 is made of a composite material, for example as a winding body, which is not described in detail. It is envisaged that the composite material of the inner shell 52 contains a predeterminable proportion of superconducting material, so that no additional superconducting elements are required to cause a magnetic interaction between the inner shell 52 and the permanent magnets 37 on the outer shell 3. For additional support of the inner shell 52 and a liquid contained therein, permanent magnets 36 can be provided on the inside at the bottom of the inner shell 52 and on the outer surface 31 of the inner shell 52. These are intended for magnetic interaction with permanent magnets 37, which are each arranged adjacent to the permanent magnets 36 and are also partially fixed to the outer surface of the outer shell 3.

In the fourth embodiment according to FIG. 4, the same reference signs are used for functionally identical components as in the first embodiment according to FIG. 1. The insulating device 61 is designed as a section of piping in which both the inner shell 62 and the outer shell 63 have a constant, for example circular, profile along a profile section 73. Accordingly, sealing connections are provided between the inner shell 62 and the outer shell 63 at opposite end regions of the insulating device 61, in each case using a sealing element 16.

Superconductors 68, preferably arranged at regular intervals along the axis of symmetry 11, are arranged in a circular ring shape on an outer surface 75 of the inner shell 62, purely by way of example. Permanent magnets 69 are arranged in the radial direction opposite the superconductors 68, which are designed as ring magnets and are fixed to an inner surface 74 of the outer shell 63. The insulating film arrangement 76 is adapted to the diameter of the inner shell 62 and the outer shell 63, which diameter is reduced compared with the other insulating devices 1, 41 and 51.

1. An insulating device for insulating a useable space from an external environment, having an inner shell which bounds a useable space and which is surrounded by an outer shell, the inner shell being movably accommodated in the outer shell and delimiting an insulating space with the outer shell, and the inner shell being assigned a superconductor, and with a magnet assigned to the outer shell, which magnet enables a force-transmitting interaction with the superconductor for the contactless provision of supporting forces for the inner shell.

2. The insulating device according to claim 1, wherein the insulation space between the inner shell and the outer shell is gas-tight.

3. The insulating device according to claim 1, wherein a support element which is elastically deformable or shape-changing is arranged in the insulating space between the inner shell and the outer shell, which support element supports the weight of the inner shell.

4. The insulating device according to claim 1, wherein the magnet is arranged in a movable manner on the outer shell.

5. The insulating device according to claim 1, wherein the inner shell has a constant profile along a profile section and wherein a plurality of permanent magnets and/or superconductors are provided along the profile section.

6. The insulating device according to claim 1, wherein the inner shell is a tube and wherein the outer shell is a tube and wherein the inner shell is connected to the outer shell in a sealing manner at each end.

7. The insulating device according to 1, wherein the inner shell is bottle-shaped and has an opening for the useable space, the bottle-shaped outer shell being connected to the inner shell in a sealing manner in the region of a mouth opening of the bottle-shaped outer shell.

8. The insulating device according to claim 7, wherein a first superconductor is arranged adjacent to a bottom region of the bottle-shaped inner shell and wherein a permanent magnet and/or a second superconductor is located on a side wall of the bottle-shaped inner shell, which side-wall is formed between the bottom region and a neck region of the inner shell.

9. The insulating device according to claim 1, wherein the inner shell is made, at least in some areas, of a composite material which comprises a proportion of superconductor material.

10. The insulating device according to claim 1, wherein an insulating layer is arranged in the insulation space.

11. A method for producing an insulating device having an inner shell which bounds a useable space and which is surrounded by an outer shell, the inner shell being movably accommodated in the outer shell and delimiting an insulating space with the outer shell, and the inner shell being assigned a superconductor, and with a magnet assigned to the outer shell, which magnet enables a force-transmitting interaction with the superconductor for the contactless provision of supporting forces for the inner shell, wherein the inner shell is produced by a method from the group: producing the inner shell by wrapping a winding form with one or more tape materials which are at least partially made of superconductor material or comprise superconductor material; producing the inner shell by plastic injection molding using a thermoplastic material which contains a proportion of superconducting particles; producing the inner shell by a casting process using a thermosetting material that contains a proportion of superconducting particles; producing the inner shell by coating an inner surface and/or an outer surface of a container blank with a superconducting material; and wherein in a subsequent step, the inner shell is inserted into the outer shell.
